(19) United States
(12) Patent Application Publication
(10) Pub. No.: US 2010/0121792 A1
(43) Pub. Date: May 13, 2010

(54) Directed Graph Embedding

(76) Inventors: Qiong Yang, Beijing (CN); Mo Chen, Beijing (CN); Xiaoou Tang, Beijing (CN)

Correspondence Address: LEE & HAYES, PLLC, 601 W. RIVERSIDE AVENUE, SUITE 1400, SPOKANE, WA, 99201, US

(21) Appl. No.: 12/521,985

(22) PCT Filed: Jan. 7, 2008
(86) PCT No.: PCT/US2008/050451

§ 371 Date: Jan. 6, 2010

Related U.S. Application Data
(63) Continuation of application No. 11/848,190, filed on Aug. 30, 2007, now abandoned.
(60) Provisional application No. 60/883,691, filed on Jan. 5, 2007.
(60) Provisional application No. 60/883,691, filed on Jan. 5, 2007.

(51) Int. Cl. G06N 5/02; G06F 15/18; G06F 7/548

(52) U.S. Cl. 706/12; 706/52; 708/441; 706/46

(57) ABSTRACT

Directed graph embedding is described. In one implementation, a system explores the link structure of a directed graph and embeds the vertices of the directed graph into a vector space while preserving affinities that are present among vertices of the directed graph. Such an embedded vector space facilitates general data analysis of the information in the directed graph. Optimal embedding can be achieved by measuring local affinities among vertices via transition probabilities between the vertices, based on a stationary distribution of Markov random walks through the directed graph. For classifying linked web pages represented by a directed graph, the system can train a support vector machine (SVM) classifier, which can operate in a user-selectable number of dimensions.

One listing used in accordance with the subject matter is provided in Appendix A after the Abstract on 1 sheet of paper and incorporated by reference into the specification. The listing is a mathematical proof supporting the subject matter.

### BACKGROUND

There are many complex systems that can be represented naturally as directed graphs, such as web information retrieval systems that are based on hyperlink structure; document classification based on citation graphs; protein clustering based on pair-wise alignment scores, etc. For example, the network structure of the World Wide Web can be represented as a directed graph, but it is not easy to usefully visualize features of the World Wide Web in the form of a directed graph. Only sparse work has been done in the area of general data analysis of directed graphs to provide meaningful results such as classification and clustering of graph nodes (e.g., web pages) according to context and importance.

A semi-supervised learning algorithm for classification of directed graphs has been proposed, and also an algorithm to partition directed graphs. An algorithm has also been proposed to do clustering on protein data formulated into a directed graph, based on asymmetric pair-wise alignment scores. However, up to now, work has been quite limited due to the difficulty in exploring the complex structure of directed graphs.

Some work has been done in embedding with respect to undirected graphs. Manifold learning techniques connect data into an undirected graph in order to approximate the manifold structure that the data is assumed to be lying on. The vertices of the graph are then embedded into a low dimensional space. Edges of the graph reflect the local affinity of node pairs in the input space. Then, an optimal embedding is achieved by preserving such a local affinity. However, in the case of directed graphs, the edge weight between two graph nodes is not necessarily symmetric and cannot be directly used as a measure of affinity. Thus, this conventional technique is not applicable to directed graphs.

### SUMMARY

Directed graph embedding is described. In one implementation, a system explores the link structure of a directed graph and embeds the vertices of the directed graph into a vector space while preserving affinities that are present among vertices of the directed graph. Such an embedded vector space facilitates general data analysis of the information in the directed graph. Optimal embedding can be achieved by measuring local affinities among vertices via transition probabilities between the vertices, based on a stationary distribution of Markov random walks through the directed graph. For classifying linked web pages represented by a directed graph, the system can train a support vector machine (SVM) classifier, which can operate in a user-selectable number of dimensions.

This summary is provided to introduce the subject matter of directed graph embedding, which is further described below in the Detailed Description. This summary is not intended to identify essential features of the claimed subject matter, nor is it intended for use in determining the scope of the claimed subject matter.

### BRIEF DESCRIPTION OF THE DRAWINGS

FIG. 1 is a diagram of web pages and accompanying link structure providing an example directed graph for exemplary directed graph embedding.

FIG. 2 is a diagram of an exemplary directed graph embedding system.

FIG. 3 is a block diagram of an exemplary directed graph embedding engine.

FIG. 4 is a diagram of example data analysis and classification results enabled by the exemplary directed graph embedding engine.

FIG. 5 is a diagram of example multi-class data resolution enabled by the exemplary directed graph embedding engine.

FIG. 6 is a diagram of example two-class (binary) classification results, in which there are twenty dimensions.

FIG. 7 is a diagram of example multi-class data analysis results.

FIG. 8 is a diagram of example multi-class data analysis results in different dimensional spaces by using a nonlinear support vector machine (SVM) after directed graph embedding.

FIG. 9 is a diagram of accuracy versus number of dimensions in classification results for a fixed 500 sample training set by using a linear SVM after directed graph embedding.

FIG. 10 is a flow diagram of an exemplary method of directed graph embedding.

### DETAILED DESCRIPTION

### Overview

This disclosure describes directed graph embedding systems and methods. An exemplary system embeds vertices of a directed graph into a vector space by analyzing the link structure of graphs. While it is difficult to directly perform general data analysis on a directed graph, embedding the directed graph information into vector space allows many conventional techniques designed for vector space to process the data. For example, there are many data mining and machine learning techniques, such as Support Vector Machine (SVM) for operating on data in a vector space or an inner product space. Thus, embedding the directed graph data into a vector space is quite appealing for the task of data analysis:

Directly analyzing data on directed graphs is quite hard, since some concepts such as distance, inner product, and margin, which are important for data analysis, are hard to define in a directed graph. But for vector data, these concepts are already well defined. Tools for analyzing vector data can be easily obtained.

Given a huge directed graph with complex link structure, it is very difficult to perceive the latent relations of the data. Such information may be inherent in the topological structure and link weights. Embedding these data into vector spaces helps humans to analyze these latent relations visually.

Instead of having to design new algorithms that are directly applied to link structure data to perform each data mining task on directed graphs, an exemplary system provides a unified framework to embed the link structure data into the vector space, and then allows mature algorithms that already exist for mining on the vector space to be utilized.

In one implementation, the exemplary system formulates the directed graph in a probabilistic framework. An important aspect of directed graph embedding is to preserve the locality property of vertices of the directed graph when embedded in the vector space (also known as the “embedded space”). Locality property refers to the relative importance of a given node in a directed graph and its local affinity with respect to its neighboring nodes. That is, in the exemplary system, the context of a node within the directed graph is preserved when embedded into a vector space. The exemplary system uses random walks to measure the local affinity of vertices on the directed graph. Based on that, an exemplary technique embeds nodes of the directed graph into a vector space by using a random walk metric.

Further, in one implementation, the exemplary system uses a transition probability together with a stationary distribution of Markov random walks to measure such locality property. By exploring the directed links of the graph using random walks, the system obtains an optimal embedding in the vector space that preserves the local affinity that is inherent in the directed graph.

Experiments on both synthetic data and real-world web page data are also considered herein. Application of the exemplary system to web page classification provides a significant improvement over conventional state-of-the-art techniques.

Example Directed Graph

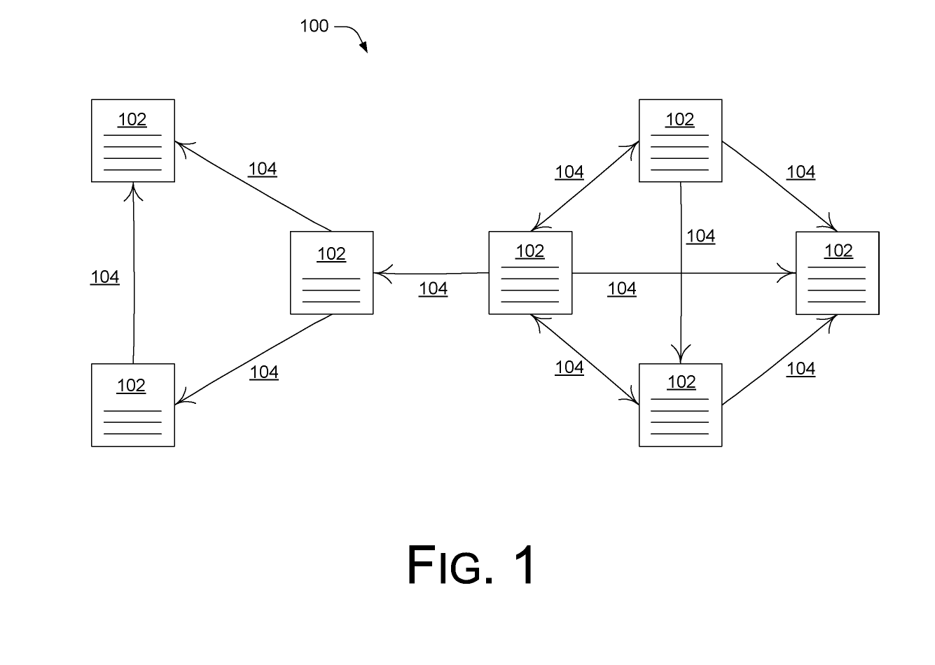

FIG. 1 shows the World Wide Web 100, which can be modeled as a directed graph. Web pages 102 and hyperlinks 104 can be represented as the vertices and directed edges of the directed graph. The World Wide Web 100 is used herein as a representative example of information relationships that can be modeled as a directed graph. But a directed graph can model many other different types of systems, information relationships, and schemata. Thus, the exemplary systems and techniques described herein can operate with directed graphs that represent many other types of physical, conceptual, and informational relationships.

A directed graph G=(V,E) consists of a finite vertex set V, which contains n vertices, together with an edge set E [symbol] V×V. An edge of a directed graph is an ordered pair (u,v) from vertex u to vertex v. Each edge may have an associated positive weight w. An unweighted directed graph can be viewed simply as a graph in which the weight of each edge is one. The out-degree d_{O}(v) of a vertex v is defined as

$${d}_{O} ( v ) = {\sum }_{u , v -> u} w ( v , u ) ,$$

where the in-degree d_{I}(v) of a vertex v is defined as

$${d}_{I} ( v ) = {\sum }_{u , u -> v} w ( u , v ) ,$$

where u→v means that u has a directed link pointing to v. On the directed graph, the exemplary system can define a primitive transition probability matrix P=[p(u,v)]_{u,v} of a Markov random walk through the graph. It satisfies

$${\sum }_{v} p ( u , v ) = 1 , ∀ u .$$

In one implementation, the stationary distribution for each vertex v is assumed to be

$${π}_{v} ( {\sum }_{v} {π}_{v} = 1 ) ,$$

which can be guaranteed if the chain is irreducible. For a connected directed graph, a natural definition of the transition probability matrix can be p(u,v)=w(u,v)/d_{O}(u), in which a random walker on a node jumps to its neighbors with a probability proportion to the edge weight. For a general graph, the system may define a slightly different transition matrix, discussed further below.

Exemplary System

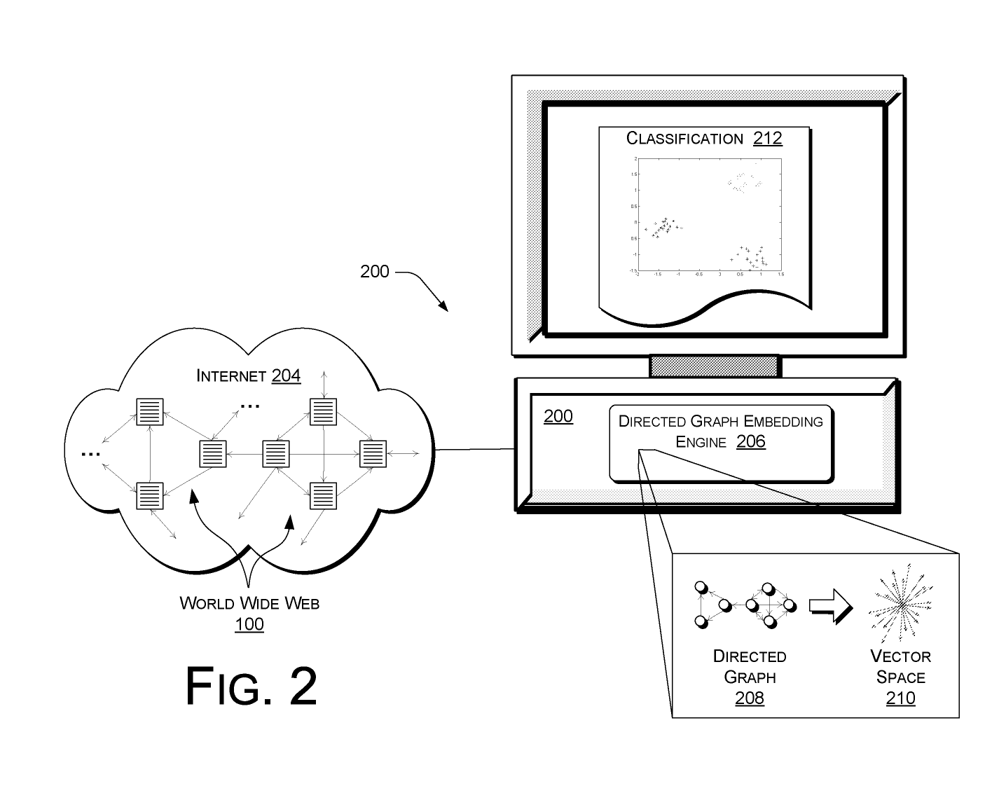

FIG. 2 shows an exemplary directed graph embedding system 200. A computing device 202, such as a desktop or mobile computer, is coupled with a source of a directed graph. Using the World Wide Web 100 as an example source for creating a directed graph, the computing device 202 may be coupled with the Internet 204, the medium of the World Wide Web 100.

The computing device 202 hosts a directed graph embedding engine 206, i.e., an engine that embeds the nodes of a directed graph 208 into vector space 210. By embedding the directed graph 208 into vector space 210, the directed graph embedding engine 206 allows easier general data analysis of the information represented by the directed graph 208. Example results of general data analysis on the vector space 210 are represented symbolically in FIG. 2 as a classification 212 of the directed graph nodes.

Exemplary Engine

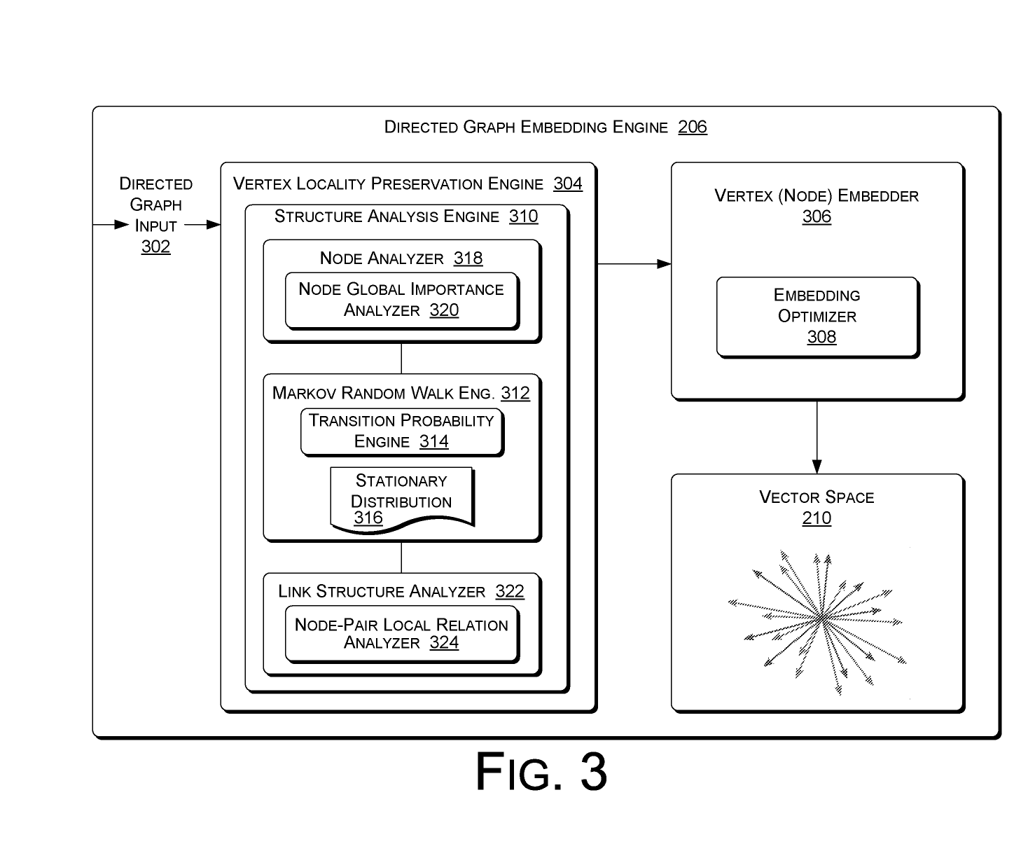

FIG. 3 shows one implementation of the directed graph embedding engine 206 of FIG. 2, in greater detail. The illustrated implementation is only one example configuration, for descriptive purposes. Many other arrangements of the components of an exemplary directed graph embedding engine 206 are possible within the scope of this described subject matter. Such an exemplary directed graph embedding engine 206 can be executed in hardware, software, or combinations of hardware, software, firmware, etc.

One implementation of the exemplary directed graph embedding engine 206 includes a directed graph input 302. Other implementations of the directed graph embedding engine 206 may include an optional modeling engine (not shown) that creates a directed graph 208 (instead of inputting one) by modeling suitable phenomenon, such as modeling the World Wide Web 100.

The directed graph embedding engine 206 further includes a vertex locality preservation engine 304 to preserve local affinities of the directed graph 208 in the embedding process, and a vertex (node) embedder 306, including an embedding optimizer 308, to embed the directed graph 208 in vector space 210, as will be described in greater detail below.

In one implementation, the vertex locality preservation engine 304 includes a structure analysis engine 310 to determine the importance and local affinities of each vertex in the directed graph 208. The structure analysis engine 310 includes a Markov random walk engine 312 that operates on and/or maintains a stationary distribution 316 of Markov random walks and includes a transition probability engine 314 for determining a transition probability of the Markov random walks between vertices.

The Markov random walk engine 312 is coupled to a node analyzer 318 that includes a node global importance analyzer 320, and to a link structure analyzer 322 that includes a node-pair local relation analyzer 324. Other configurations of the directed graph embedding engine 206 may include different components and/or different arrangements of the components.

Operation of the Exemplary Engine

The vertex locality preservation engine 304 preserves the affinities of each vertex u to its neighboring vertices in a directed graph 208. The vertex embedder 306 aims to embed the vertices of the directed graph 208 into a vector space 210 while the embedding optimizer 308 maintains for each vertex the locality property extracted by the vertex locality preservation engine 304.

Consider the problem of mapping a connected directed graph 208 to a line. A general optimization target is defined as in Equation (1):

$${\sum }_{u} {T}_{V} ( u ) {\sum }_{v , u -> v} {T}_{E } ( u , v ) {( {y}_{u} - {y}_{v} )}^{2} \qquad ( 1 )$$

The term yᵤ is the coordinate of vertex u in embedded one-dimensional space. The term T_{E} is used to measure the importance of a directed edge between two vertices. If T_{E} (u,v) is large, then the two vertices u and v should be close to each other on the embedded line. The term T_{V} is used to measure the importance of a vertex on the directed graph 208. If T_{V}(u) is large, then the relation between vertex u and its neighbors should be emphasized. By minimizing such a target, an optimized embedding for the graph in 1-dimensional space can be obtained. The embedding considers both the local relation of node pairs and global relative importance of nodes.

In one implementation, the directed graph embedding engine 206 addresses the embedding task with two assumptions: 1) two vertices are related if there is edge between them—the node-pair local relation analyzer 324 represents the strength of the relation by a related edge weight; and 2) an out-link of a vertex that has many out-links carries relatively low information about the relation between vertices.

These two assumptions are reasonable for many different tasks. Using the World Wide Web 100 again as an example, web page authors usually insert links to pages related to their own web pages 102. Therefore, if a web page A has a hyperlink to web page B, it is reasonable to assume that web page A and web page B are related in some sense. The vertex locality preservation engine 304 tries to preserve such a relation in the embedded vector space 210.

Likewise, consider a web page 102 that has many out-links, such as the home page of www.YAHOO.COM. A page linked to the home page of YAHOO may have little similarity with the home page, and so in the embedded feature vector space 210 the two web pages 102 should have a relatively large distance. The transition probability engine 314 determines the transition probability of random walks for each vertex to measure the corresponding locality property. When a web page 102 has many out-links, each out-link will have a relatively low transition probability. Such a measure meets assumption #2, described above.

Different web pages 102, that is, different nodes in the directed graph 208, also have different importance in a web environment. Ranking web pages according to their importance is a well-studied area. The stationary distribution 316 of random walks on the link-structure environment is also well-known as a good measure of such importance which is used in many ranking algorithms including PAGERANK. In order to emphasize the important pages (nodes) in the embedded feature vector space 210, the Markov random walk engine 312 uses the stationary distribution πᵤ 316 of a random walk to weigh the web page u 102 in the optimization target.

Taking the above considerations into account, the optimization target can be rewritten as in Equation (2):

$${\sum }_{u} {π}_{u} {\sum }_{v , u -> v} p ( u , v ) {( {y}_{u} - {y}_{v} )}^{2} \qquad ( 2 )$$

The formula can further be rewritten as in Equation (3):

$$\begin{matrix}{\sum }_{u} {π}_{u} {\sum }_{v , u -> v} p ( u , v ) {( {y}_{u} - {y}_{v} )}^{2} = {\sum }_{u , v} {( {y}_{u} - {y}_{v} )}^{2} {π}_{u} p ( u , v ) \\ = \frac{1}{2} ( \begin{matrix}{\sum }_{u , v} {( {y}_{u} - {y}_{v } )}^{2} {π}_{u} p ( u , v ) + \\ {\sum }_{v , u} {( {y}_{v} - {y}_{u} )}^{2} {π}_{v } p ( v , u )\end{matrix} ) \\ = \frac{1}{2} {\sum }_{u , v} {( {y}_{u} - {y}_{v} )}^{2} ( \begin{matrix}{π}_{u} p ( u , v ) + \\ {π}_{v} p ( v , u )\end{matrix} )\end{matrix} \qquad ( 3 )$$

Thus, the problem is equivalent to embedding the vertices of the directed graph 208 into a line while preserving the local symmetric measure (πᵤp(u,v)+πᵥp(v,u))/2 of each pair of vertices. Here, πᵤp(u,v) is the probability of a random walker jumping to vertex u then to v, i.e., the probability of the random walker passing the edge (u,v). This can also be deemed the percentage of flux in a total flux at stationary state when random walkers are continuously imported into the graph. This directed force manifests the impact of u on v, or in a web environment, the volume of messages that u conveys to v.

In optimizing the target, the embedding optimizer 308 considers not only the local property relation reflected by the edge between a pair of vertices, but also a global reinforcement of that relation that results from taking the stationary distribution 316 of random walks into account.

A combinatorial Laplacian on a directed graph 208 is denoted in Equation (4):

$$L = Φ - \frac{Φ P + {P}^{T} Φ}{2} \qquad ( 4 )$$

where P is the transition matrix, i.e. Pᵢⱼ=p(i,j), and Φ is the diagonal matrix of the stationary distribution 316, i.e., Φ=diag(π₁, . . . , πₙ) (see, F. R. K. Chung, “Laplacians and the Cheeger inequality for directed graphs,” Annals of Combinatorics, 9, 1-19, 2005). Clearly, from the definition, L is symmetric. This gives rise to the following proposition in Equation (5):

$$Proposition 1 \text{:} {\sum }_{u} {π}_{u} {\sum }_{v , u -> v} p ( u , v ) {( {y}_{u} - {y}_{v} )}^{2} = 2 {y}^{T} Ly \qquad ( 5 )$$

where y=(y₁, . . . , yₙ)^{T}.

The proof of this proposition is given in Appendix A. From proposition 1, L is a semi-positive definite matrix. Therefore, the minimization problem reduces to finding, as in Equation (6):

$${argmin}_{y} {y}^{T} Ly \\ s . t . {y}^{T} Φ y = 1 \qquad ( 6 )$$

The constraint y^{T}Φy=1 removes an arbitrary scaling factor of the embedding. Matrix Φ provides a natural measure of the vertex on the directed graph 208. The problem is solved by the general eigendecomposition problem as given in Equation (7):

Ly=λΦy. (7)

Alternatively, y^{T}y=1 can be used as the constraint. Then the solution is achieved by solving Ly=λy.

If e is a vector with all entries of 1, it can be shown that e is an eigenvector with eigenvalue 0, for L. If the transition matrix is stochastic, e is the only eigenvector for λ=0. The rationale for the first eigenvector is to map all data to a single point, which minimizes the optimization target. To eliminate this trivial solution, an additional orthogonality constraint can be placed, as in Equation set (8):

$${arg min}_{y} {y}^{T} Ly \\ s . t . \\ {y}^{T} Φ y = 1 \\ {y}^{T} Φ e = 0 \qquad ( 8 )$$

Then, the solution is given by the eigenvector of smallest non-zero eigenvalue. Generally, embedding the directed graph 208 into R^{k} (k>1) is given by the n×k matrix Y=[y₁ . . . yₖ], where the ith row provides the embedding of the ith vertex. Therefore, the Equation (9) is minimized:

$${\sum }_{u} {π}_{u} {\sum }_{v , u -> v} p ( u , v ) {‖ {Y}_{u} - {Y}_{v} ‖}^{2} = 2 tr ( {Y}^{T} LY ) . \qquad ( 9 )$$

This reduces to Equation (10):

min tr(Y^{T}LY)

s·t·Y^{T}ΦY=I (10)

The solution is given by Y*=[v₂*, . . . , vₖ₊₁*] where vᵢ* is the eigenvector of ith lowest eigenvalue of the generalized eigenvalue problem Ly=λΦy.

Example Process

The following Table (1) summarizes one exemplary method executed by the exemplary directed graph embedding engine 206. The exemplary “directed graph embedding method” of Table (1) embeds vertices from a directed graph 208 into a vector space 210:

TABLE (1)
Input: adjacency matrix W, dimension of
target space k, and a perturbation factor α

| | |
|---|---|
| 1. | $\begin{matrix}Compute P = α ( {D}_{o}^{- 1} W + \frac{1}{n} μ {e}^{T} ) + ( 1 - α ) \frac{1}{n} {ee}^{T} , where μ is a vector \\ that {μ}_{i} = 1 if row i of W is 0 , and {D}_{o} is the diagonal matrix of the \\ out degrees .\end{matrix}$ |
| 2. | Solve the eigenvalue problem π^{T}P = π^{T} subject to a normalized |
| | equation π^{T}e = 1. |
| 3. | $\begin{matrix}Construct the combinatorial Laplacian of the directed graph \\ L = Φ - \frac{Φ P + {P}^{T} Φ}{2} , where Φ = diag ( {π}_{1} , … , {π}_{n} ) .\end{matrix}$ |
| 4. | Solve the generalized eigenvector problem Ly = λΦy, let |
| | v₁*, . . . , vₙ* be the eigenvectors ordered according to their |
| | eigenvalues with v₁* having the smallest eigenvalue λ₁ (in fact zero). |
| | The image of Xᵢ embedded into k dimensional space is given by |
| | Y* = [v₂*, . . . , vₖ₊₁*]. |

The irreducibility of the Markov chain guarantees that the stationary distribution vector π exists. The Markov random walk engine 312 builds a Markov chain with a primitive transition probability matrix P. In general, for a directed graph 208, the matrix of transition probability P defined by p(u,v)=w(u,v)/d_{O}(u) is not irreducible. In one implementation, the transition probability engine 314 uses the “teleport random walk” on a general directed graph 208 (see, A. Langville and C. Meyer, “Deeper inside PageRank,” Internet Mathematics, 1(3), 2004). The transition probability matrix is given by Equation (11):

$$P = α ( {D}_{o}^{- 1} W + \frac{1}{n} μ {e}^{T} ) + ( 1 - α ) \frac{1}{n} e {e}^{T} \qquad ( 11 )$$

where W is the adjacent matrix of the directed graph, μ is a vector that μᵢ=1 if row i of W is 0, and D_{O} is the diagonal matrix of the out degree. Then P is stochastic, irreducible and primitive. This can be interpreted as a probability α of transiting to an adjacent vertex and a probability 1−α of jumping with uniform randomness to any point on the directed graph 208. For those vertices that do not have any out edge, the method can just jump with uniform randomness to any point on the directed graph 208. Such a setting can be viewed as adding a perturbation to the original directed graph 208. The smaller the perturbation, the more accurate result is obtainable. So in practice α is set to a very small value. For example, α can simply be set to 0.01.

The stationary distribution vector then can be obtained by solving such an eigenvalue problem π^{T}P=π^{T} subject to a normalized equation π^{T}e=1.

### Experimental Results

Relation to Previous Works

In M. Belkin and P. Niyogi, in “Laplacian eigenmaps and spectral techniques for embedding and clustering,” NIPS, 2002, the authors propose a Laplacian Eigenmap algorithm for nonlinear dimensional reduction. If the exemplary method described herein is applied to an undirected graph the solution is sometimes more or less similar to a Laplacian Eigenmap. In the case of an undirected graph, the transition probability can be defined as p(u,v)=w(u,v)/dᵤ, where w(u,v) is the weight of the undirected edge (u,v), and dᵤ is the degree of vertex u. If the graph is connected, then the stationary distribution on vertex u can be proved equal to dᵤ/Vol(G), where Vol(G) is the volume of the graph, thus

$$\begin{matrix}\begin{matrix}{\sum }_{u} {π}_{u} {\sum }_{v , u -> v} p ( u , v ) {( {y}_{u} - {y}_{v} )}^{2} = {\sum }_{u , v} {( {y}_{u} - {y}_{v} )}^{2} {π}_{u} p ( u , v ) \\ = {\sum }_{u , v} {( {y}_{u} - {y}_{v} )}^{2} w ( u , v ) / Vol ( G )\end{matrix} & \\ {y}^{T} Φ y = {y}^{T} Dy / Vol ( G ) & \end{matrix}$$

where D=diag(d₁, . . . , dₙ). Then the problem reduces to the Laplacian Eigenmap.

In D. Zhou, J. Huang, and B. Schölkopf, “Learning from Labeled and Unlabeled Data on a Directed Graph,” ICML, 2005 (the “Zhou et al., 2005 reference”), a semi-supervised classification algorithm on a directed graph is proposed by solving an optimization function. The basic assumption is the smooth assumption that the class labels of the vertices on the directed graph should be similar if the vertices are closely related. The algorithm minimizes a regularization risk between the least square risk and a smooth term. If the data in the same class is scattered and the decision boundary is complicated, then the smooth assumption does not hold. In such case, classification results may be hindered. Another problem is that by using least square error the data far away from the decision boundary also contributes a large penalty in the optimization target. Thus considering the imbalanced data, the side with more training data may have more total energy, and the decision boundary is biased. Further below, a comparison is described between Zhou's algorithm and the exemplary method described herein used together with a support vector machine (SVM) classifier.

In the above-cited D. Zhou et al., the authors also propose the directed version of a normalized cut algorithm. The solution is given by the eigenvector corresponding to the second largest eigenvalue of matrix Θ=(Φ^{1/2}PΦ^{-1/2}+Φ^{-1/2}P^{T}Φ^{1/2})/2. It can be seen that the eigenvector corresponding to the second largest eigenvalue of Θ is in fact the eigenvector v corresponding to the second largest eigenvalue of L≡I−Θ. The exemplary method can use a similar technique shown in Equation (12):

$$\frac{{y}^{T} Ly}{{y}^{T} Φ y} = \frac{{v}^{T} {Φ}^{- 1 / 2} L {Φ}^{- 1 / 2} v}{{v}^{T} v} = \frac{{v}^{T} L v}{{v}^{T} v} , y = {Φ}^{- 1 / 2} v = \qquad ( 12 )$$

Therefore, the cutting result is equal to embedding data into a line by the exemplary directed graph embedding method, then using threshold 0 to cut the data.

Exemplary Experimental Data

Experiments show the effectiveness of the exemplary directed graph embedding method for both embedding problems and for practical applications to classification tasks. Some experiments were designed to show the exemplary embedding effect in both mock-up problems and in real-world data. Application of the exemplary directed graph embedding method to a web page classification problem is also presented, with a number of comparisons to a conventional state-of-the-art algorithm.

Mock-Up Problems

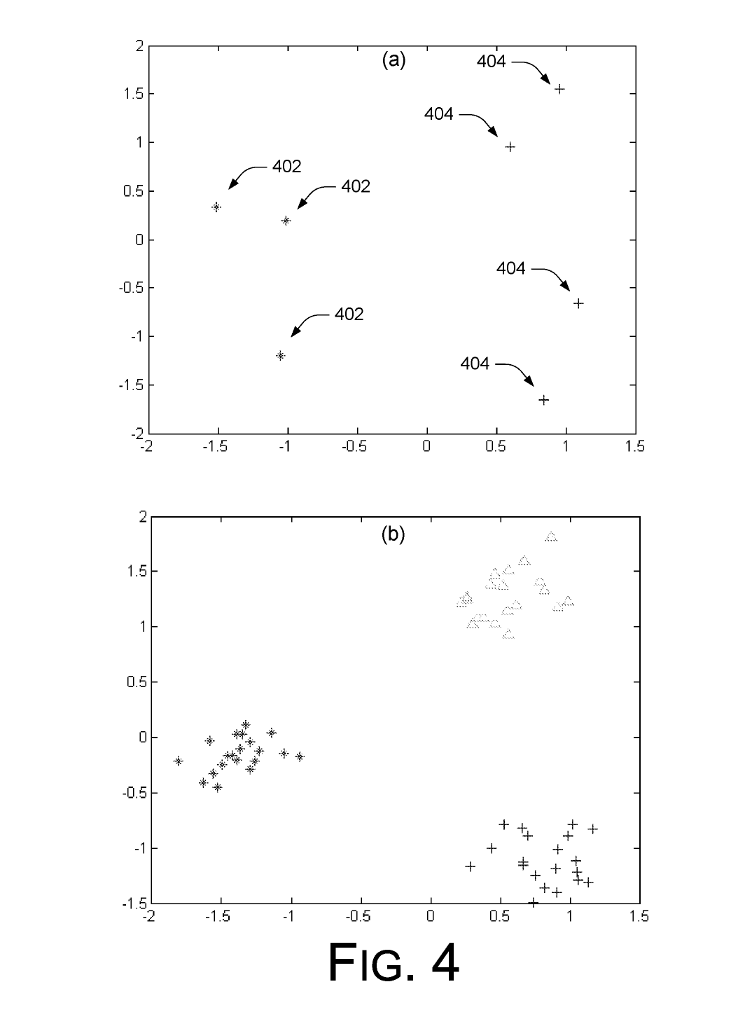

FIG. 4 shows embedding results from the directed graph embedding engine 206 of two mock-up problems in 2-dimensional space. FIG. 4(a) shows the result of embedding a directed graph into a plane. A first type of nodes 402 and a second type of nodes 404 in FIG. 4(a) correspond respectively to the three nodes on the “left” and four nodes on the “right” in the World Wide Web of FIG. 1. From FIG. 4(a), it is evident that the vertex locality preservation engine 304 has preserved the locality property of the directed graph 208 well, and the embedding result reflects subgraph structure of the original directed graph 208 derived from the web pages 102 and link structure 104 in FIG. 1.

In another experiment, a directed graph consisting of 60 vertices is generated. There are three subgraphs, and each consists of 20 vertices. Weights of the inner directed edges in the subgraph are drawn uniformly from the interval [0.25, 1]. Weights of directed edges between the subgraphs are drawn uniformly from the interval [0, 0.75]. By generating the edge weights in such a manner, each subgraph is relatively impacted. The graph is a full-connected directed graph 208. If only given the graph without a prior knowledge of the data, it is difficult to see any latent relation in the data. However, the embedding result by the exemplary directed graph embedding engine 206 in 2-dimensional space is shown in FIG. 4(b). In FIG. 4(b), it is apparent that tightly related nodes on the directed graph 208 are clustered in the 2-dimensional Euclidean vector space 210. After embedding the data into the vector space 210, the clustered structure of the original graph is easily perceived, and provides insight about principal issues, such as latent complexity of the directed graph 208.

Web Page Data Experiments

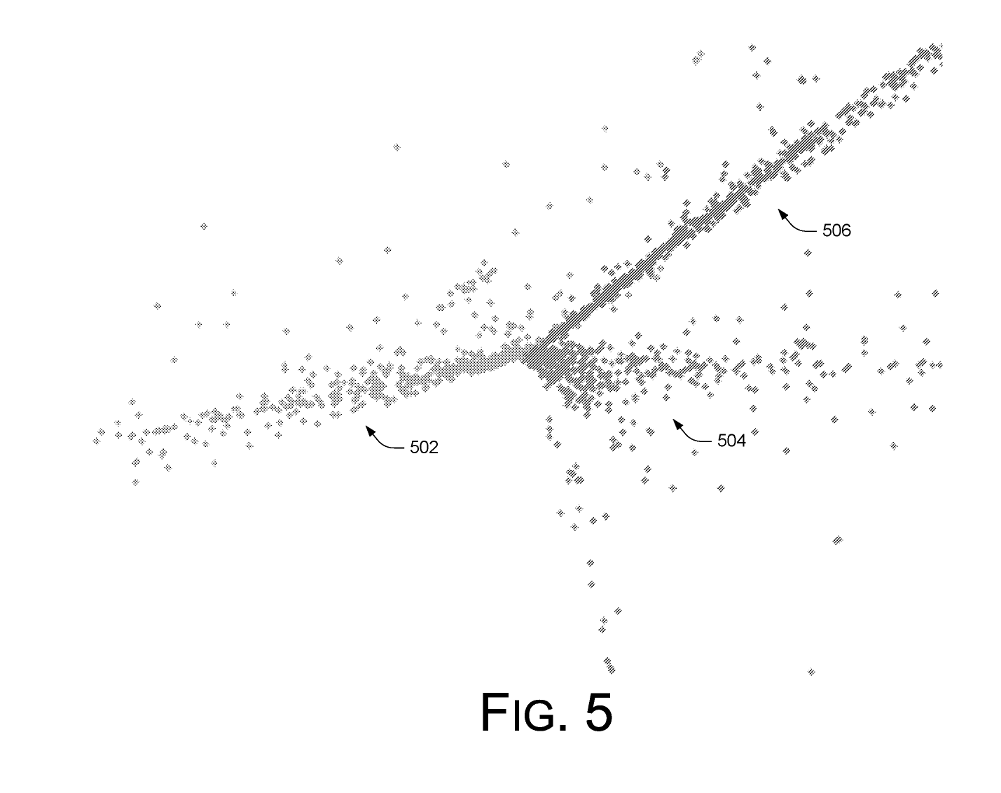

The WebKB dataset was utilized to address application of the exemplary directed graph embedding engine 206 and related methods on real world data. A subset was selected containing web pages of three universities: Cornell, Texas, and Wisconsin. After removing isolated pages, the remaining web pages numbered 847, 809, and 1227, respectively. A weight could have been assigned to each hyperlink according to the textual content or the anchor text. In this experiment, however, the structure analysis engine 310 focused on link structure only and hence adopted a binary weight function. FIG. 5 shows embedding results of the WebKB data in 3-dimensional space. The first cluster 502, second cluster 504, and third cluster 506 of nodes correspond to the web pages of the three universities: Cornell, Texas, and Wisconsin, respectively. From FIG. 5 it is evident that the embedding results of the web pages for each university are relatively impacted, while those of web pages across different universities are well separated. FIG. 5 strikingly shows that the exemplary directed graph embedding engine 206 is effective for enabling analysis of link structure across different universities, where the inner links within the web page structure of any one university are denser than that between universities.

Application in Web Page Classification

The exemplary directed graph embedding engine 206 can be applied in many applications, such as classification, clustering, and information retrieval. As another example, the directed graph embedding engine 206 was applied to a web page classification task. Web pages of four universities Cornell, Texas, Washington, and Wisconsin in the WebKB dataset were employed. The binary edge weight setting is again adopted. In this experiment, the directed graph embedding engine 206 embeds the vertices into a certain Euclidean vector space 210, and then an SVM classifier was trained to do the classification task. Results were compared with a conventional state-of-the-art classification algorithm proposed in the Zhou et al., 2005 reference cited above. A modified version of SVM known as nu-SVM was used for easy model selection (see, B. Schölkopf and A. J. Smola, Learning with kernels, Cambridge, Mass., MIT Press, 2002). Both linear and nonlinear SVM were tested. In the nonlinear setting, a radial basis function (RBF) kernel is used. The training data were randomly sampled from the data set. To ensure that there was at least one training sample for each class, the sampling was conducted again when there was no labeled point for some class. The testing accuracies were averaged over 20 sets of experimental results. Different dimensional embedding spaces were also considered to study the dimensionality of the embedded space.

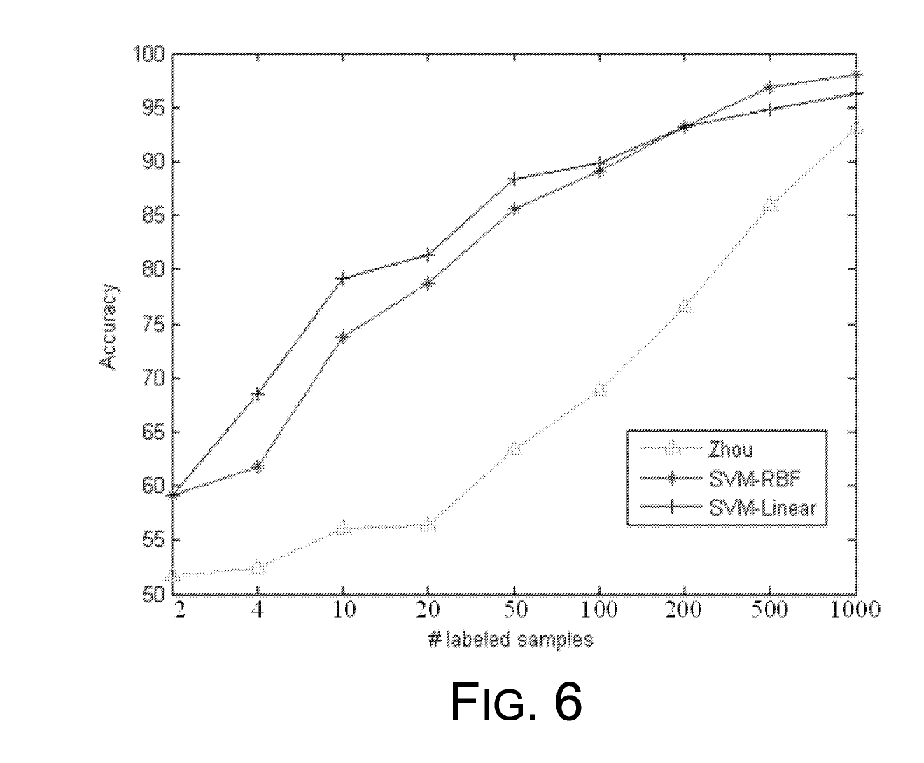

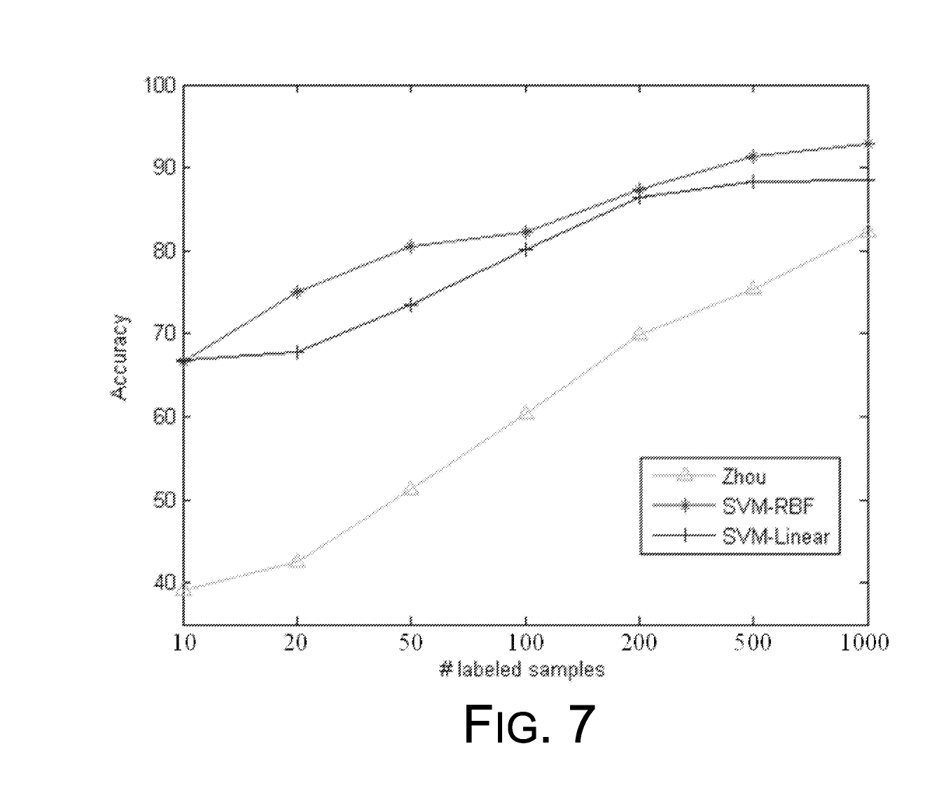

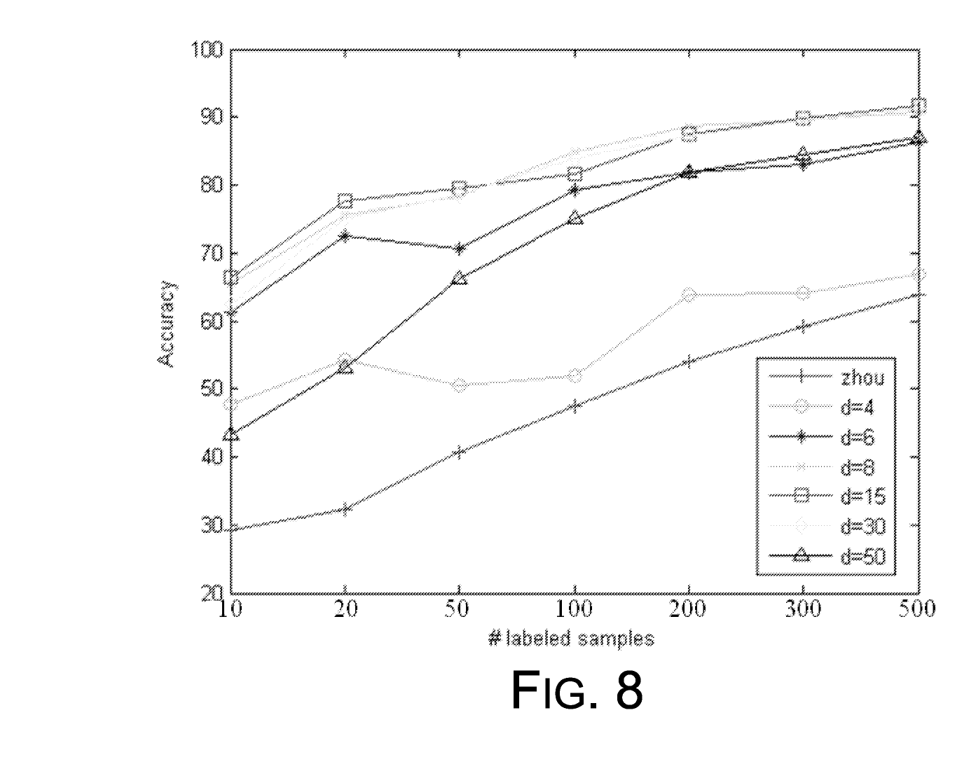

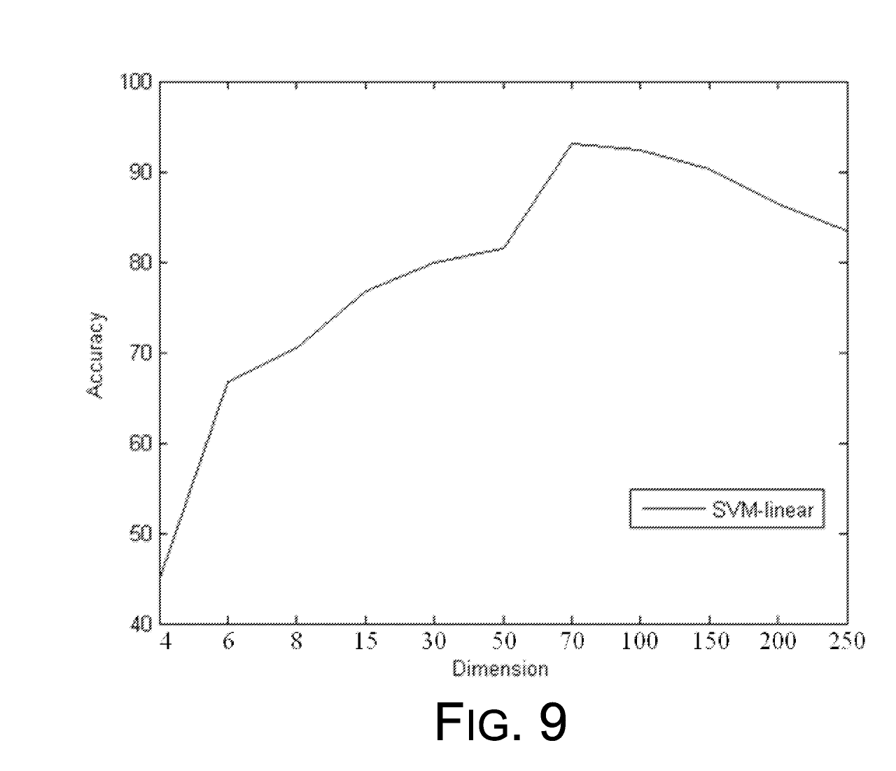

FIGS. 6-9 show exemplary classification results. FIG. 6 depicts a two-class (binary) problem, in which there are twenty dimensions. In FIG. 7 a multi-class problem with twenty dimensions is shown. FIG. 8 shows a multi-class problem in different dimensional spaces by nonlinear SVM. FIG. 9 shows accuracy versus dimensionality on a fixed (500 labeled samples) training set by linear SVM.

The comparative results of the binary classification problem are shown in FIG. 6. The web pages of two Universities randomly selected from the WebKB data set were used as input. The exemplary directed graph embedding engine 206 embedded the entire dataset into a 20-dimensional space, then used SVM to do the classification. The parameter nu was set to 0.1 for both linear SVM and nonlinear SVM. The parameter 6 of the RBF kernel is set to 38 for nonlinear SVM. The parameter α for Zhou's algorithm is set to 0.9 as proposed in the Zhou reference. In FIG. 6, it is apparent that in all cases where the number of training samples varies from 2 to 1000, the exemplary directed graph embedding engine 206 with nonlinear SVM consistently achieves better performance than Zhou's algorithm. When the number of training samples is large, linear SVM also outperforms Zhou's algorithm. The reason might be that Zhou's technique directly applies the least square risk to the directed graph 208, which is convenient and suitable for regression problems, but not as efficient in some types of classification problems, such as imbalanced data. The reason is that the nodes far away from the decision boundary also contribute a large penalty affecting the shape of the decision boundary. But by comparison, after the directed graph embedding engine 206 embeds the data into vector space 210, the decision boundary can be analyzed more carefully. Nonlinear SVM also shows an advantage in such circumstances.

FIG. 7 shows the result of the multi-class problem, in which each university is considered as a single class, and then training data are randomly sampled. For SVM, a one-against-one extension is used for the multi-class problem. For Zhou's algorithm, the multi-class setting in D. Zhou, O. Bousquet, T. Lal, J. Weston, and B. Schölkopf, “Learning with Local and Global Consistency,” NIPS, 2004 is used. The parameter setting is the same as for the binary class experiment of FIG. 6. From FIG. 7, it is apparent that significant improvements are achieved by the exemplary directed graph embedding engine 106. Zhou's method is not very efficient for the multi-class problem.

Besides the previously described reasons, another problem with Zhou's algorithm is the smooth assumption. When the data in one class are scattered in the space, the smooth assumption cannot be well satisfied, and the decision boundary is complicated, especially in the case of the multi-class problem. Directly analyzing the decision boundary on the graph is a difficult task. When embedding the data into vector space 210, complicated geometrical analysis can be performed and sophisticated alignment of the boundary can be achieved using methods such as nonlinear SVM.

The number of different dimensions utilized in the classification task can also be user-selectable. The same parameter setting for SVM can be used for training models on different dimensional spaces. FIG. 8 shows comparative experimental results of nonlinear SVM on embedded vector spaces 210 in which the dimensionality of the embedded vector space 210 varies from 4 to 50. From FIG. 8, it is evident that when the exemplary directed graph embedding engine 206 embeds the data into vector space 210, the classification accuracies are higher than Zhou's algorithm in a wide range of dimension settings.

FIG. 9 shows the result of linear SVM on the dimensionality settings ranging from 4 to 250. The best result appears to be achieved on approximately 70-dimensional vector space 210. In spaces of lower dimension, the data may not be linearly separable, but still have a rather clear decision boundary. This is why nonlinear SVM works well in those cases (as in FIG. 8). In a higher number of dimensions, the data become more linearly separable, and the classification errors become lower. When the dimensionality is larger than 70, the data become too sparse to train a good classifier, which hinders the classification accuracy. The experimental results suggest that the data on the directed graph 208 may have a latent dimension in a Euclidean vector space 210.

Exemplary Method

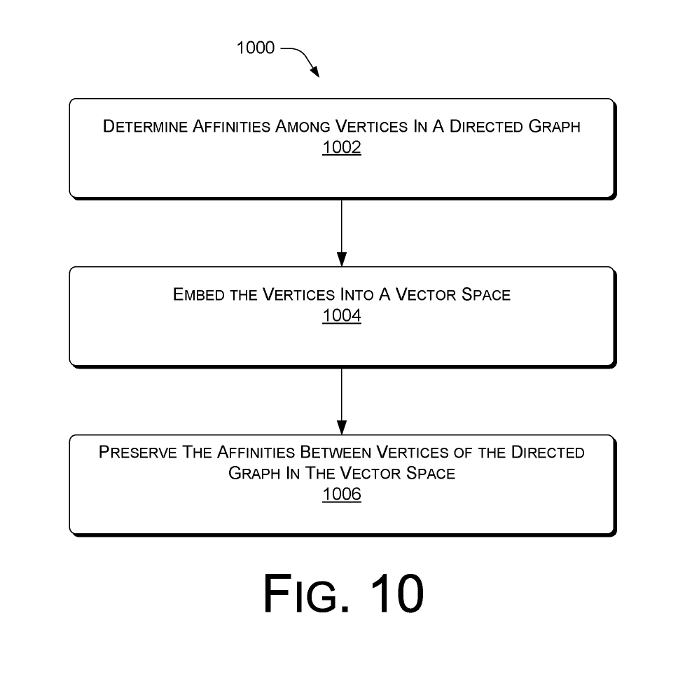

FIG. 10 shows an exemplary method 1000 of directed graph embedding. In the flow diagram, the operations are summarized in individual blocks. The exemplary method 1000 may be performed by hardware, software, or combinations of hardware, software, firmware, etc., for example, by components of the exemplary directed graph embedding engine 206.

At block 1002, affinities are determined among vertices in a directed graph. For example, a relationship such as directed edge strength between neighboring nodes of the directed graph is determined. The strength of relationships can be measured by examining out-links from a given vertex, for example. In one implementation, transition probabilities between vertices are estimated, e.g., with respect to a stationary distribution of Markov random walks through the directed graph. The importance of a node may also be estimated by number of out-links, magnitude of transition probabilities, etc.

At block 1004, the vertices of the directed graph are embedded into a vector space. In one implementation, a combinatorial Laplacian of the directed graph is constructed and solved as a generalized eigenvector problem. The vector space can be operated on by a host of data analysis techniques that cannot be applied to the directed graph. For instance, information in the directed graph, once embedded in the vector space, can be classified by training a support vector machine (SVM) learning engine, in a variable/selectable number of dimensions.

At block 1006, the embedding includes preserving in the vector space, the affinities between vertices of the directed graph. Preserving such node-pair relationships optimizes the embedding with respect to representing in the vector space the edges and edge strengths of the directed graph, as well as the relative importance of each vertex and each edge. Such faithful representation in the vector space of the vertices and their relationships in the directed graph, allows many types of general data analysis and classification techniques to be applied to the vector space—that cannot be easily applied to the directed graph itself.

### CONCLUSION

Although exemplary systems and methods have been described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A method, comprising:
determining affinities among vertices in a directed graph;
embedding the vertices into a vector space; and
preserving the affinities in the vector space.

2. The method as recited in claim 1, wherein the affinities are local affinities between each vertex and its neighboring vertices.

3. The method as recited in claim 1, wherein determining affinities further comprises determining a local relation between member vertices of node pairs of the directed graph and a global relative importance of each node in the directed graph.

4. The method as recited in claim 3, wherein determining the local relation between member vertices of node pairs includes determining that two vertices are related if there is an edge between them in the directed graph, and further comprising:
assigning an edge weight to the edge based on a strength of the relation between the member vertices; and
representing the edge weight in the vector space as a preserved affinity of the members of the node pair.

5. The method as recited in claim 1, wherein determining affinities among vertices in the directed graph further comprises applying random walks to explore a link structure of the directed graph.

6. The method as recited in claim 5, further comprising determining transition probabilities of a Markov random walk through the directed graph.

7. The method as recited in claim 6, further comprising establishing a stationary distribution of Markov random walks for each vertex and determining a transition probability associated with each neighboring vertex.

8. The method as recited in claim 7, wherein a random walker on the vertex jumps to its neighboring vertices with a probability proportional to the edge weight between the vertex and each neighboring vertex.

9. The method as recited in claim 7, wherein the transition probability and the stationary distribution of Markov random walks preserves the pair-wise relationship of vertices inherent in the directed graph.

10. The method as recited in claim 7, wherein the transition probability and the stationary distribution of Markov random walks preserves the relative importance of each edge in the directed graph.

11. The method as recited in claim 1, further comprising training a support vector machine (SVM) learning process operating on the vector space for classifying data represented by the directed graph.

12. The method as recited in claim 11, further comprising selecting a number of dimensions for the classifying.

13. A vector space, comprising:
vertices; and
vertex-pair relationships of a directed graph.

14. The vector space as recited in claim 13, in which the vertices of the directed graph are embedded such that relationships of the vertices in the directed graph are preserved in the vector space.

15. The vector space as recited in claim 13, wherein the vector space enables data analysis of the directed graph.

16. The vector space as recited in claim 15, wherein a support vector machine (SVM) learning technique enables the data analysis.

17. A directed graph embedding engine, comprising:
a vertex locality preservation engine to determine affinities between vertices of a directed graph; and
a vertex embedder to enter each vertex of the directed graph into a vector space while preserving the affinities.

18. The directed graph embedding engine as recited in claim 17, further comprising a random walk engine to determine the affinities by establishing transition probabilities between the vertices based on a stationary distribution of Markov random walks.

19. The directed graph embedding engine as recited in claim 18, further comprising:
a classifier to perform data analysis on the directed graph as embedded in the vector space; and
wherein the data analysis is performed in a user-selectable number of dimensions.

20. A computer-executable method, comprising:
inputting an adjacency matrix W, with a dimension of target space k and a perturbation factor α;
computing
$$P = α ( {D}_{o}^{1} W + \frac{1}{n} μ {e}^{T} ) + ( 1 - α ) \frac{1}{n} e {e}^{T} ,$$
where μ is a vector that μᵢ=1 if row i of w is 0, and D_{O} is the diagonal matrix of the out degrees;
computing an eigenvalue problem π^{T}P=π^{T} subject to a normalized equation π^{T}e=1;
constructing a combinatorial Laplacian of the directed graph
$$L = Φ - \frac{Φ P + {P}^{T} Φ}{2} ,$$
where Φ=diag(π₁, . . . , πₙ); and
calculating a generalized eigenvector problem Ly=λΦy, letting v₁*, . . . , vₙ* be the eigenvectors ordered according to their eigenvalues, with v₁* having a smallest eigenvalue λ₁ (e.g., zero), wherein the image of Xᵢ embedded into k dimensional space is given by Y*=[v₂*, . . . , vₖ₊₁*].
